(19) United States
(12) Patent Application Publication
(10) Pub. No.: US 2009/0097657 A1
(43) Pub. Date: Apr. 16, 2009

(54) Constructive Channel Key

(76) Inventors: Edward M. Scheidt, Vienna, VA (US); C. JAY Wack, Vienna, VA (US); Wai Tsang, Falls Church, VA (US); Roger Butler, Centerville, VA (US); Ron Parsons, Ijamsville, MD (US)

Correspondence Address: IP STRATEGIES, 12 1/2 WALL STREET, SUITE E, ASHEVILLE, NC, 28801, US

(21) Appl. No.: 12/246,257

(22) Filed: Oct. 6, 2008

Related U.S. Application Data
(60) Provisional application No. 60/978,025, filed on Oct. 5, 2007.

(51) Int. Cl. H04L 9/06

(52) U.S. Cl. 380/277

(57) ABSTRACT

A method of generating a constructive channel key includes providing an issuer with a card public key as the keying part of a CKM credential. An ephemeral key pair is computed by the issuer using pre-established enterprise domain parameters. A shared value for the ephemeral private key and the card public key is computed using D-H key agreement. The ephemeral private key is destroyed. The shared value is combined with a static key value. The static key value is split into four blocks. The first block is truncated to be used for a session encryption key. The second block is truncated to be used for a session MAC key. The third block is truncated to be used for a session key encryption key. The fourth block is truncated to be used for an initial IVEC.

### CROSS-REFERENCE TO RELATED DOCUMENTS

This document incorporates the disclosures of the following U.S. patents in their entireties:

U.S. Pat. No. 7,131,009 Multiple factor-based user identification and authentication
U.S. Pat. No. 7,111,173 Encryption process including a biometric unit
U.S. Pat. No. 7,095,852 Cryptographic key split binder for use with tagged data elements
U.S. Pat. No. 7,095,851 Voice and data encryption method using a cryptographic key split combiner
U.S. Pat. No. 7,089,417 Cryptographic information and flow control
U.S. Pat. No. 7,079,653 Cryptographic key split binding process and apparatus
U.S. Pat. No. 7,069,448 Context oriented crypto processing on a parallel processor array
U.S. Pat. No. 7,016,495 Multiple level access system
U.S. Pat. No. 6,845,453 Multiple factor-based user identification and authentication
U.S. Pat. No. 6,754,820 Multiple level access system
U.S. Pat. No. 6,694,433 XML encryption scheme
U.S. Pat. No. 6,684,330 Cryptographic information and flow control
U.S. Pat. No. 6,608,901 Cryptographic key split combiner
U.S. Pat. No. 6,606,386 Cryptographic key split combiner
U.S. Pat. No. 6,549,623 Cryptographic key split combiner
U.S. Pat. No. 6,542,608 Cryptographic key split combiner
U.S. Pat. No. 6,490,680 Access control and authorization system
U.S. Pat. No. 6,266,417 Cryptographic communication process and apparatus
U.S. Pat. No. 6,229,445 RF identification process and apparatus
U.S. Pat. No. 6,075,865 Cryptographic communication process and apparatus
U.S. Pat. No. 5,898,781 Distributed cryptographic object method
U.S. Pat. No. 5,787,173 Cryptographic key management method and apparatus
U.S. Pat. No. 5,680,452 Distributed cryptographic object method
U.S. Pat. No. 5,432,851 Personal computer access control system
U.S. Pat. No. 5,410,599 Voice and data encryption device
U.S. Pat. No. 5,375,169 Cryptographic key management method and apparatus
U.S. Pat. No. 5,369,707 Secure network method and apparatus
U.S. Pat. No. 5,369,702 Distributed cryptographic object method

CKM is also embodied in numerous standards (X9.69. X9.73, X9.84, X9.96) published by the American National Standards Institute (ANSI) and is being incorporated into ISO 22895 which includes reference to the cited ANSI standards. These standards are also incorporated herein by reference.

This document claims priority under 35 USC §119(e) of U.S. Provisional Application for Patent No. 60/978,025, which was filed on Oct. 5, 2007.

### FIELD OF THE INVENTION

The present invention relates to systems that provide security and privacy for data. In particular, the present invention allows flexible access for authorized users of a communication system authorized while maintaining security for data at rest and in transit on the system.

### BACKGROUND OF THE INVENTION

### ANSI X9.69—Framework for Key Management Extensions

This standard and other ANSI standards have been implemented for securing financial services in the United States. The framework for CKM is identified in the standard. A multi-tier architecture is illustrated that can offer a scalable enterprise solution. The elements of the CKM administration are described in the standard. The Key Establishment portion of key management is defined so that designated groups of user can establish keys for data encryption via a key derivation procedure, thus avoiding key distribution in the usual sense.

### X9.73—Cryptographic Message Syntax

The Standard specifies a cryptographic message syntax that can be used to protect financial transactions and other documents from unauthorized disclosure and modification. CKM is defined for message protection that is used in the financial sector. It is encoded in the ASN.1 coding scheme to offer additional efficiency in transmission.

### X9.84—Biometric Information Management and Security for the Financial Services Industry

This Standard specifies the minimum-security requirements for effective management of biometric data. In additional to various aspects of managing of biometrics, the integrity and privacy protection of biometric data is defined. CKM is recognized as an encryption framework that can be used to protect the biometric data.

### X9.96—XML Cryptographic Message Syntax (XCMS)

This Standard specifies a text based Cryptographic Message Syntax (CMS) represented using XML 1.0 encoding that can be used to protect financial transactions and other documents from unauthorized disclosure and modification. The message syntax has the following characteristics: 1) Protected messages are represented using the Canonical XML Encoding Rules (cXER), and can be transferred as verbose markup text or in a compact, efficient binary representation using the Basic Encoding Rules (BER) or the canonical subset of BER, the Distinguished Encoding Rules (DER) 2) Messages are protected independently. There is no cryptographic sequencing (e.g., cipher block chaining) between messages. There need not be any real-time connection between the sender and recipient of the message. This makes the syntax suitable for use over store-and-forward systems, e.g. Automated Clearing House (ACH) or Society for Worldwide International Funds Transfer (SWIFT). Standard attributes are defined to allow applications to maintain relationships between messages, if desired. 3) The syntax is algorithm independent. It supports confidentiality, integrity, origin authentication, and non-repudiation services. Only ANSI X9-approved algorithm(s) may be used for message digest, message encryption, digital signature, message authentication, and key management. 4) Support for biometric security, enhanced certificate techniques such as compact domain certificates and key management extensions such as Constructive Key Management (CKM) are provided. 5) Selective field protection can be provided in two ways. First, by combining multiple instances of this syntax into a composite message; and second, by using identifier and type markup tag names to select message components to be protected in a single message, which allows reusable message components to be moved between documents without affecting the validity of the signature. 6) Precise message encoding and cryptographic processing requirements are provided.

These standards are available at

http://webstore.ansi.org/ansidocstore/default.asp

### Draft ISO 22895—Financial Services—Security—Cryptographic Syntax Scheme

The standard is based on the combination of inputs from ANSI X9.73 and ANSI X9.96 and is being updated to reflect the current direction in protecting messaging for the international financial community. A cryptographic message schema is defined whose concrete values can be represented using either a compact binary encoding or a human-readable XML markup format. CKM is identified as a key management framework that can be applied to protecting content or information.

### BRIEF SUMMARY OF THE INVENTION

A method of generating a constructive channel key includes providing an issuer with a card public key as the keying part of a CKM credential. An ephemeral key pair is computed by the issuer using pre-established enterprise domain parameters. A shared value for the ephemeral private key and the card public key is computed using D-H key agreement. The ephemeral private key is destroyed. The shared value is combined with a static key value. The static key value is split into four blocks. The first block is truncated to be used for a session encryption key. The second block is truncated to be used for a session MAC key. The third block is truncated to be used for a session key encryption key. The fourth block is truncated to be used for an initial IVEC.

### BRIEF DESCRIPTION OF THE DRAWINGS

FIG. 1 a block diagram of encryption using a digital signature, according to the present invention.

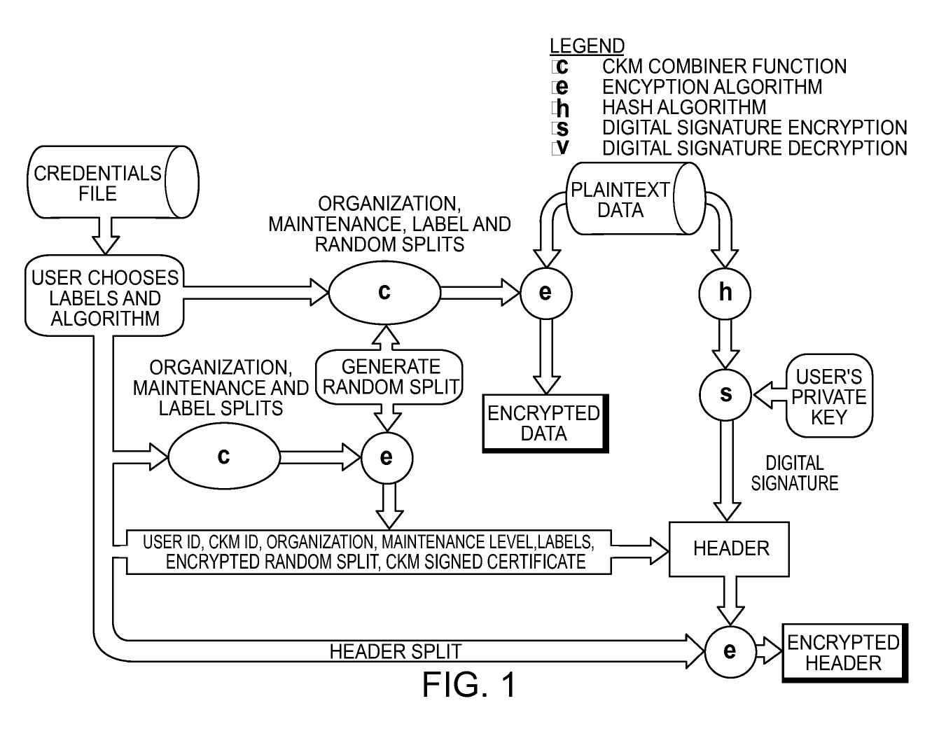

FIG. 2 is a block diagram of decryption with digital signature verification, according to the present invention.

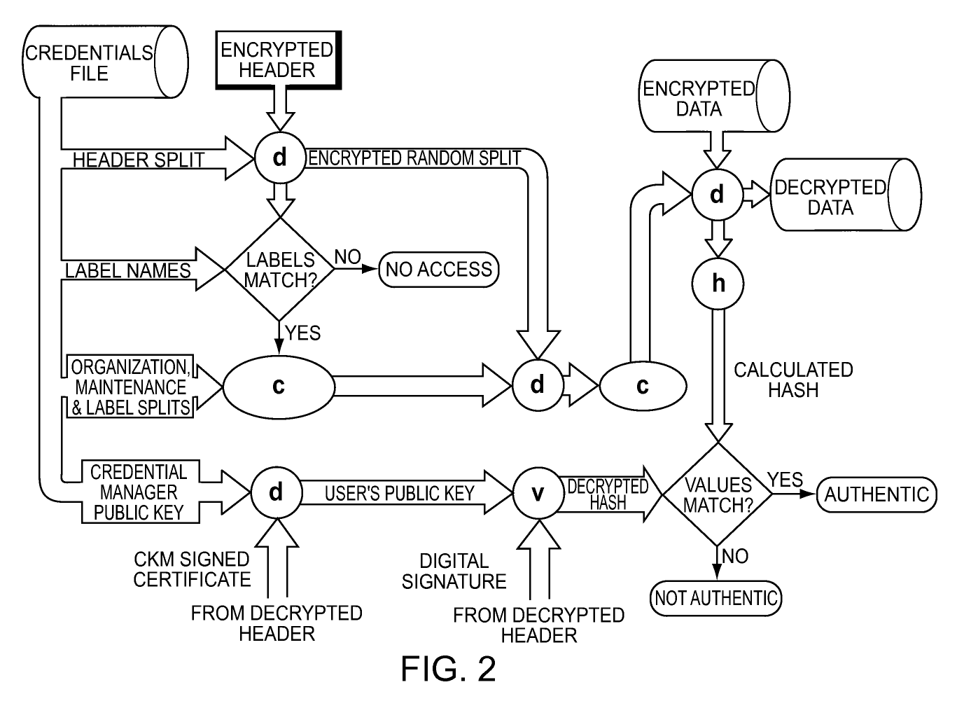

FIG. 3 is a block diagram of first actions in a process of user session establishment according to the present invention.

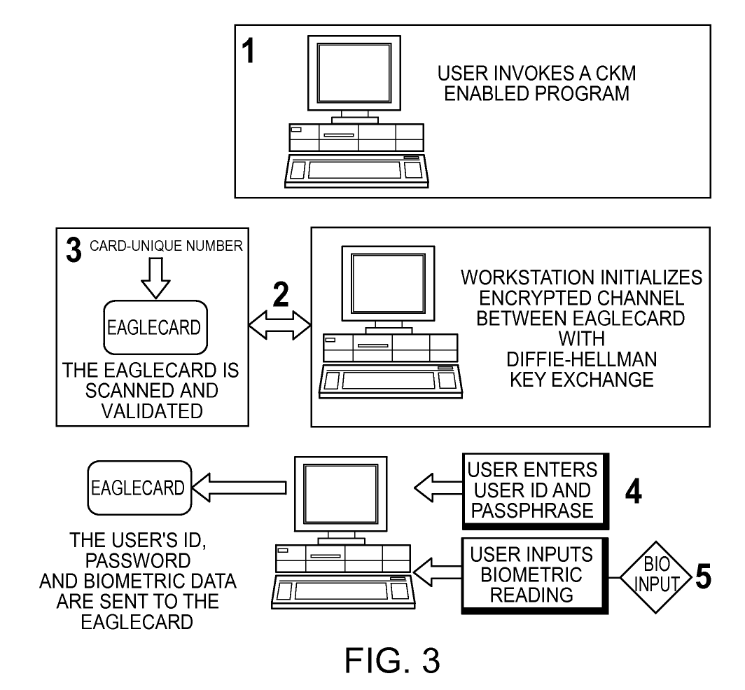

FIG. 4 is a block diagram of second actions in a process of user session establishment according to the present invention.

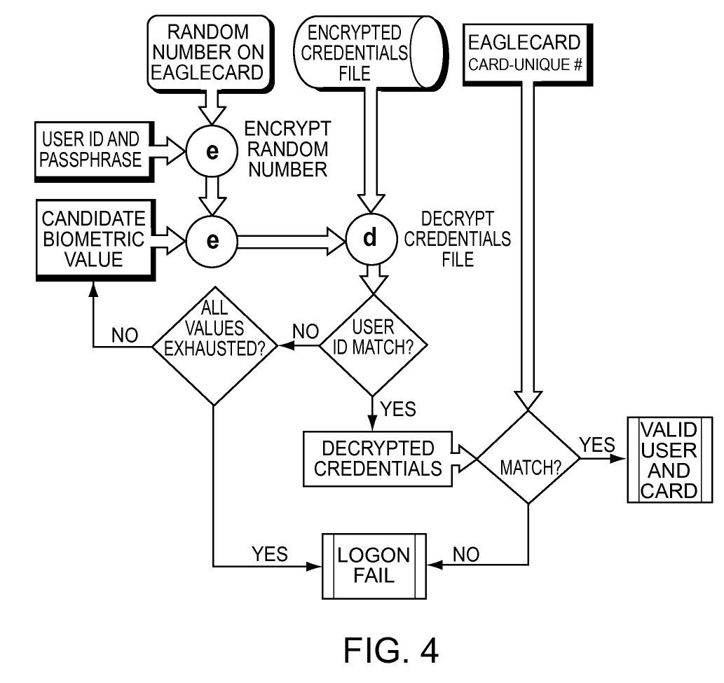

FIG. 5 is a block diagram of third actions in a process of user session establishment according to the present invention.

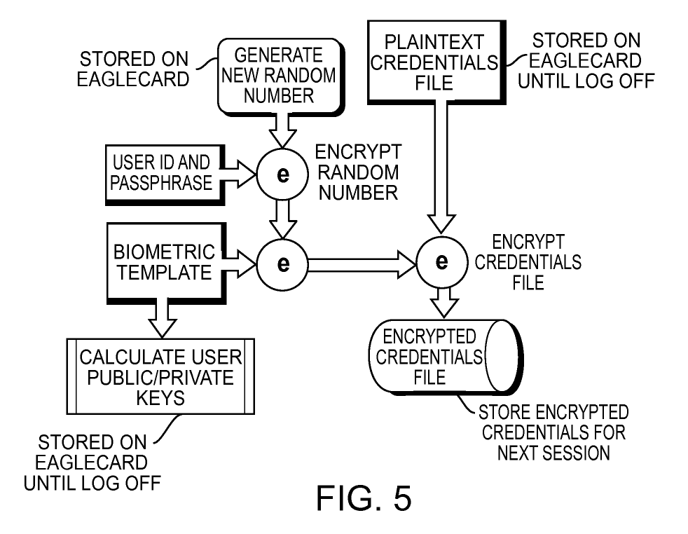

FIG. 6 is a block diagram of credentials initialization according to the present invention.

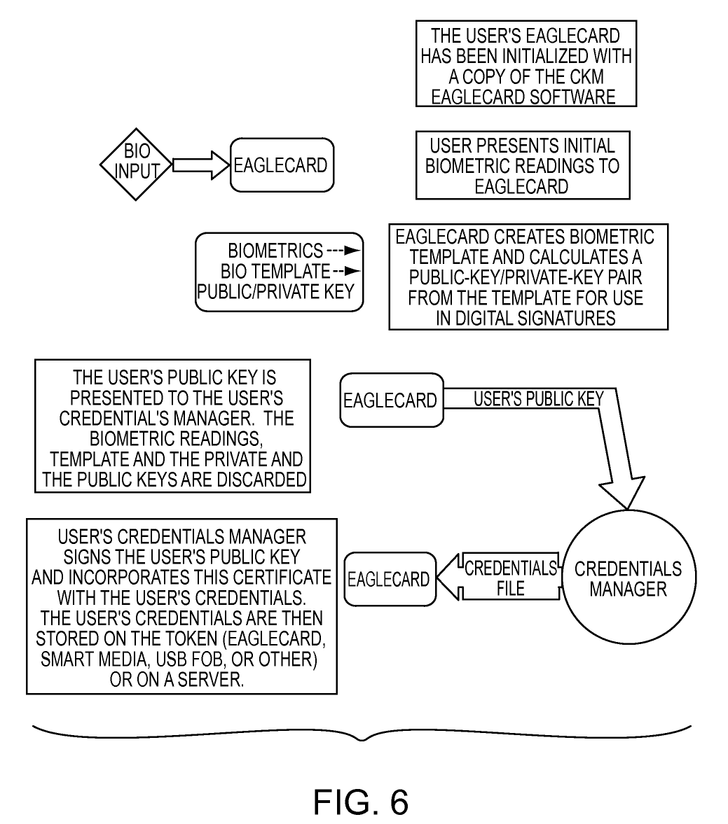

### DETAILED DESCRIPTION OF THE INVENTION

### CKM Overview

As an information security tool, cryptography can complement changes in information technology. The growth of information systems has been phenomenal. However, today's cryptography and its key management have reached a crossroads as it attempts to adapt to the information system changes. The predominant public key management scheme of the 1980s and 1990s has shortcomings that will constrain the information industry from expanding into greater information sharing applications without a shift in public key application. A new direction in encryption is needed if the distributed enterprise solution, with its myriad information applications, is to be made effective.

By combining what has been learned in the implementations of public key management and pre-1980s key management, an expanded symmetrical core key management technology emerges as the better choice for bridging to the 21^{st} century information applications that include data-at-rest and communications security models. Issues that confront future information protection models such as scalar, data separation, or role-based enforcement, system performance, and multiple enterprise authentication for the user or for the workstation can be satisfied by combining enterprise-wide information distribution with information control and access control capabilities while protecting the information.

An evolution in cryptographic technology is taking place. A symmetrical key management Framework that is particularly well suited for role-based access control systems that look to the roles users have within an organization, and to the information access that should be afforded those roles is being bound to an authentication key management model that incorporates the mathematical models of digital signatures and signed public certificates with physical properties of identification techniques as smart cards. The resultant key management Framework is the basis for what will be referred to herein as Constructive Key Management (CKM).

In recent years, both government and industry have dramatically altered their perceptions of the development and expansion of information systems. The personal computer (PC) heralded in the practical management of information. As its power and flexibility increased, the communications industry expanded its services and capabilities to accommodate the automated enterprise and its users. The rapid drop in prices and explosive development of both hardware and software compounded the personal computer's potential power.

Rapid growth is also evident in the conveyance of information on the software side. The entertainment world now produces games using terms like Virtual Reality and Cyber Immersion. This rapid advancement of information technologies has provided a somewhat uneven growth pattern, particularly in the sociological and legal arenas. Today, even the casual user has a headlong rush of information available at a level that did not exist ten years ago. We have moved from the micro-controller, to the micro-processor, and to today's multi-core-processor systems with complexities that even the most prescient PC gurus did not foresee. As we have become more familiar with the capabilities of our machinery, we have followed the most human of instincts: we attempt to share our discoveries.

The sharing of IDs has also extended to the sharing of workloads and the concept of distributive processing. The computer and communications communities responded to this demand. They have increased speed and provided connective opportunities enabling the booming of myriad connectivity links, PANs, LANs, MANs, WANs, and more and more acronyms that all mean “together.” The result today is that any user, with a reasonable amount of equipment, can connect with just about any information application over the Internet cloud (that is, cloud computing). The age of the Internet and “information warfare” is upon us. The protection of selected information and selected channels of information has become a paramount concern in defense and commerce. While this evolution has been taking place in information processing, cryptography has emerged as a premier protection technology.

Keys are an essential part of all encryption schemes. Their management can be the most critical element of any cryptography-based security. The true effectiveness of key management is the ability for keys to be maintained and distributed secretly without penalizing system performance, costs, or user interaction. The management of the keys must be scalar, must be capable of separating information flow, must include interoperability needs, and must be capable of providing information control.

A method of distributing keys predominantly used in the 1980s and 1990s is public key, or asymmetrical cryptography. In this method, the conversion of information to ciphertext and the conversion of basic properties of the public key method include separate encryption and decryption keys, difficulty in deriving one key from another, secret decryption keys, and public encryption keys. The implementation of public key information encrypting keys is the result of the mathematical combination of the encryption and decryption keys. Public key management was developed for a communications channel requirement to establish cryptographic connectivity between two points. Over the years, public key implementations have demonstrated their effectiveness to authenticate between two entities. However, to take the authentication process to a global certificate process has not been successfully done. Stated in other words, public key management is effective in an information model that defines point-to-point communications channels where the information encrypted does not need to be recovered.

Many of the recent implementations of public key management have left users with an option to create their own pair-wise connectivity within the network. This action can leave an organization vulnerable, and in some cases liable, if that user leaves the organization without identifying the keys that were previously used for encrypted files or data. Also, to assure the integrity of the public key from misuse, a third-party infrastructure scheme has surfaced, that is, a certificate authority process is created to mathematically confirm that a particular public key was issued to a specific user. The exchange of certificates with a third party can significantly impact the performance of a network. Further, this raises the legal issue of whether an organization should give a third party control over the validation of corporate correspondence.

A negative aspect of the public key process is a high computation time, which can impact the performance of an information application. In many instances, hardware solutions have compensated for the high computational requirements. Semi-public key architecture historically has been a point-to-point design; moving to a distributed network with group sharing of information can create higher transmission costs and greater network impact. Although the older key management systems of the 80's and 90's worked well for point-to-point communications and one-to-one file transfer, they are too resource intensive to use in a case wherein a single file is placed on a file server and decrypted by thousands of users.

Shared secret keys or symmetrical key is the earliest key management design and pre-dates public key management. The earlier versions of symmetrical designs suffered what was referred to as the “n-squared” problem in that the number of keys needed was very large as a network expanded, and these designs did not have an effective authentication capability. However, symmetrical encryption has a measurably better system performance than public key implementations.

CKM is a cryptographic key management Framework that uses pre-positioned key splits to build cryptographic keys when needed. CKM is an architecture that provides a complete cryptosystem for today's large distributed networks.

Keys are an essential part of all encryption schemes. Their management is a critical element of any cryptographic-based security. The true effectiveness of key management is the ability to have keys created, distributed, and maintained without requiring user interaction and without degrading system performance or increasing costs.

Asymmetric, also called public-key, cryptography has received significant attention in recent years. The public-key method includes separate public encryption and private decryption keys that provide a measure of difficulty in deriving the private key from the public key. Public-key management was developed to establish cryptographic connectivity between two points in a communications channel after which a symmetric cryptogen, such as DES (Data Encryption Standard), was to be executed. Over the years public-key implementations have demonstrated their effectiveness to authenticate between entities. However, public-key methods have not been able to successfully handle the requirements of today's globally distributed interconnecting networks.

Many of the recent public-key implementations allow users to create their own keys. This can leave an organization vulnerable, and in some cases liable, if users leave and fail to identify their private keys. Also, to ensure the integrity of public keys, third party infrastructure designs have been proposed. A Certificate Authority process confirms that a certain public key was issued to a specific user. The exchange of certificates with a third party can significantly impact the performance of a network.

The public-key process is also associated with high computation times. In many instances, hardware solutions have compensated for these high computational requirements. Since public-key architectures have been historically point-to-point designs, moving to a distributed network with group sharing of information can create higher transmission costs and greater network impact. While public-key management systems work well for point-to-point communications and one-to-one information transfer, they are too time consuming for a single file placed on a server and decrypted by thousands of users. As the trend toward work groups and complex communications infrastructures continues, the need for a more efficient information and communications key management technology becomes paramount.

Shared secret keys used with symmetric key cryptosystems is the earliest key management design and pre-dates public-key management. Early symmetric key designs suffered from the “n-squared” problem since the number of keys required becomes very large and unmanageable as the number of users increase. In addition, these designs did not have effective authentication. Symmetric encryption does have significantly better processing performance than public-key implementations.

CKM builds on the advantages, and takes into account the disadvantages, of both public-key and symmetric key implementations. CKM combines an encryption schema based on split key capability with access control credentials and an authentication process based on public-key techniques. CKM is most effective in modern distributed information models where information flow and control can be defined, where the information encrypted may need to be recovered, and where authentication using public-key technology and a physical token can be implemented. CKM can be also used to construct keys to secure an information channel that is enabled with a token or smart card functionality.

Encryption may apply to protecting a channel, which can be referred as Data-in-Transit encryption, or encryption may apply to protecting content (objects associated with content) which can be referred as Data-at-Rest encryption. Data-at-rest refers to encrypted data objects to include the information management lifecycle encompassing the create, read, update and delete phases. Data-in-transit refers to the transport of encrypted data through a physical or logical communication channel during a certain period of time. CKM through constructive key can perform both types of data leakage prevention and protection. In addition to constructive key, CKM can be used as an enforcer such as enforcing usage and access to computing memory allocation.

Current CKM technology meets the set of “classical” security objectives.
1. Data confidentiality keeps the content of information from being revealed to those who are not authorized to read it. CKM uses symmetric key cryptography with a robust key management system that provides a new and unique working key for each encryption. The user “selects” the readership or has the readership defined for each encrypted object. An object can be data-at-rest, such as a file or a message, or data-in-transit, such as network traffic packets.
2. Access control restricts use of encrypted objects to those users specifically given permission to use them. Access control in CKM can be role-based for which permissions are granted and revoked based on that user's responsibility or position within an organization. It currently encompasses the actions of encryption and decryption but may include permissions to use certain programs, certain devices or specific hardware operating modes. Access control may also be extended to data base applications.
3. User Authentication establishes the identity of a user (person or device) to the system. User authentication becomes stronger when other enhancements, discussed below are added to CKM.

Smart cards and biometrics provide CKM greater security in meeting the third objective, User Authentication. As well as providing stronger user authentication when used as a token, a smart card can be an excellent hardware platform to implement various levels of CKM technology. The card may be used as a memory only device, or it can be expanded to include processing capability. An advanced smart card, called the EagleCard™, is an enhancing technology for CKM. Along with its increased processing and memory, the EagleCard™ includes a biometric match-on-card capability.

Adding biometrics to CKM enhances user authentication and may provide pieces of information for generating the private key part for the asymmetric key cryptographic system that CKM uses for digital signatures.

Inherent in CKM is the means to meet two additional objectives:
4. Data separation is the ability to keep data in the same physical space yet still enforce access controls. Two cryptographic means of separation are used in CKM—separation by algorithm and separation by label.
5. Key recovery in CKM is the ability to regenerate the keys used to encrypt objects. Key recovery means that within any particular CKM domain (or organization) encrypted objects are not lost with the loss of any individual. Key recovery for export is also possible.

Asymmetric key cryptography used for digital signatures offers CKM the means to meet three additional security objectives concerned with message authentication:
6. Data origin authentication (sometimes called message authentication) corroborates the source of CKM encrypted information.
7. Data integrity is the ability to prove that a CKM encrypted object has not been altered since being encrypted and digitally signed. If digital signatures are not used a Message Authentication Code (MAC) or Manipulation Detection Code (MDC) with encryption can provide data integrity.
8. Non-repudiation proves that the signature on a signed object came from the signatory such that the signatory cannot deny digitally signing the object.

The basic CKM Framework focuses on the functions needed for encryption and decryption of objects and the distribution of keys. High performance symmetric key cryptographic algorithms and a key management for the lifecycle of keys are part of the Framework. The Framework is the administrative architecture to support various CKM schema to support a secure channel implementation, to support an external digital signature or support an internal dynamic CKM digital signature, or to support a constructive key used to enforce a computing application such as memory allocation.

Another level, focusing on authentication, uses smart cards and biometrics to create strong entity authentication and uses digital signatures for message authentication. A third level that adds a mix of detection techniques for internally protecting the CKM authentication and encryption processes is added when the environment requires more security.

### Overview of CKM Technology

CKM is an encryption technology and framework for generating and regenerating cryptographic keys, and managing those keys within an organization. The CKM schema has a cryptographic working key generated immediately before an object is encrypted or decrypted. It is used to initialize a cryptographic algorithm for encryption or decryption. The working key is discarded after use.

Referring to the drawings, the working key is built from many pieces of information. To be a participant in the system, a user must have the pieces necessary to build the key; otherwise encryption and decryption cannot take place. A central authority generates these pieces, which are called cryptographic key splits. A subset of these splits is distributed to each user in the organization. The subset that each user receives is specific to that person and defines what labels that individual may use to encrypt (known as write permission) and which labels that individual may use to decrypt (known as read permission). Several user authentication techniques are used to verify a user to the CKM system before that user is allowed access to this information.

To build a key, a constant system wide-split, called the organization split and a variable system wide split, called the maintenance split are used. To this are added a random number, which is called the random split, and user selected label splits. The random split ensures that a unique working key is created for each use. User selected label splits define the “readership” of the CKM encrypted object, i.e. which users will be able to decrypt the object. All of these splits are input to a process known as the CKM combiner process. The output of the combiner process is a unique number that is used as the basis for the session key.

CKM uses a hierarchical infrastructure to manage the distribution of information necessary for CKM enabled software to construct cryptographic keys. This infrastructure also provides a method of user certificate and public key distribution for asymmetric key cryptography so that digital signatures may be used.

### Infrastructure

CKM is structured as a multi-tier hierarchical system. The top tier is a process identified as the Policy Manager. This process enables the “central authority” for the encryption domain to generate splits, which in current implementations of CKM are 512 random bits, to be used in key generation. Splits are labeled and are used in combination by users to generate cryptographic keys.

The next tier in the hierarchy is a process identified as a Credential Manager. This process is given a subset of labels and specific algorithms and policies from a Policy Manager. A Credential manager and a Policy Manager are nomenclatures to identify actions that are associated with the CKM Framework. Individuals are allocated use of specific labels and algorithms from the Credential manager's subset. Organizational policies and system parameters generated by the Policy Manager are added to these labels forming an individual's credentials. A user's credentials are encrypted and distributed to that user on a “token”, such as a diskette or a smart card, or installed on a workstation or server. The process of label and algorithm allocation by the Credential manager allows an organization to implement a “role-based” system of access to information.

As a convenience to the Credential managers, password Supervisors may securely distribute “first use” passwords to users that will unlock user credentials the first time they are used.

Access to user credentials is controlled at the user tier of the CKM hierarchy with a password initially assigned by the Credential Manager. The password is changed at the time of first use by the user and is known only to the user. This provides rudimentary user authentication. Stronger authentication is provided by enhancements to CKM.

User authentication enhancements include a smart card—a processor and memory packaged into a plastic card, like a credit card—that can hold pieces of information for user authentication. It can also retain information for use by CKM and provide processing for CKM. A smart card with tamper resistance and hardware random number generation capability offers additional security.

Another authentication enhancement is the use of biometric data. Biometric data is physiological or behavioral information that is unique to each individual and that does not change during that individual's lifetime. Furthermore, it has to be something that can be digitized and used by a computer. In addition to strong user authentication, biometric data may be used in the creation of private keys for digital signatures.

For data integrity alone, a Message Authentication Code (MAC) can be used. Instead of the CKM generated key being used to initialize symmetric key algorithms, a generated key is used to initialize a MAC. Manipulation Detection Codes (MDCs) can also be used to provide data integrity and secrecy when combined with CKM encryption.

If data origin authentication, data integrity and non-repudiation are required, then the CKM infrastructure is used to provide the means to distribute public keys which give CKM the ability to use cryptographic bound digital signatures. If a digital signature is used, MACs or MDCs are not required. Combining digital signatures with the basic CKM Framework and adding user authentication enhancements establishes the means to meet the security objectives stated above.

### Combiner Function and Splits

The CKM schema includes a combiner, which is a non-linear function that takes multiple inputs and produces a single integer. The integer output is used as the session key for encrypting and decrypting objects.

The starting point for the combiner function is the organization split. Everyone in the organization has access to the split. It is equivalent to what is usually called the system key.

During encryption, a user will choose one or more label splits (which may be referred as Credential splits) to be used in the combiner process. This will define the readership of the encrypted object, as only those who have read access to splits used for encryption will be able to decrypt the object. The selection and usage of an organization's labels by users should be taken into account in designing the label set. Good label set design should mirror an organization's established information compartments. Access to labels that can be provided to a user by a Credential Manager based on the role of that user within the organization.

It is also possible, at either the Credential Manager or Policy Manager level, to specify mandatory use labels for a specific user or group of users. These correspond to label splits that are always used when the user encrypts an object. The user has no choice in their selection—they are used automatically in the combiner.

A random split, generated for each encryption, is another split that is provided as input to the combiner function to make the final working key. Because a new random split is generated at each encryption, the working key is always changing. It will not be the same even if the same object is encrypted again using the same labels. The random number should ideally come from a hardware based random number generator. However, if hardware is not available, a software based pseudo-random number generator must be used.

The maintenance split is used for key updating and compromise scenarios. The organization's policy may require that one of the splits be periodically changed. The maintenance split is changed in order to make an organization wide impact. The Policy Manager can periodically generate a new maintenance split that is distributed to users via credentials file updates. Generation of the maintenance split is done in such a manner that all the previous maintenance splits may be recovered. Thus, for data-at-rest, previously encrypted data can be recovered. For data-in-transit, such as encrypted network traffic, there is no need to recover previous maintenance splits.

The maintenance split may be used to exclude someone from the organization domain. If an individual does not have credentials which have been updated with the new maintenance split, then that individual will not be able to decrypt objects that have been encrypted using this new maintenance split. Updating the maintenance split will also protect data encrypted if a user's credentials have been compromised.

In summary, the organization split is a constant number used in all encryption. The maintenance split is used to maintain a periodic change to the working key's input. The user selects label splits, and the random split is always unique, thus ensuring that every encrypted object has a different key.

### Cryptographic Algorithms

A CKM Framework, with its pre-positioned splits in user credentials, provides key management for symmetric key cryptographic algorithms. The impact of the classical n-squared key management problem has been mitigated without resorting entirely to an asymmetric or “public-key” cryptographic system. However, the infrastructure provided for the private key management solution can also be used for public-key management. Asymmetric keys are used in CKM for message authentication and may be used for user credential distribution and for key exchange for the communications protocol between a host platform and a smartcard. Associated with keys are encryption algorithms such as DES and AES. The CKM schema that utilizes the algorithms and keys may be viewed as a modular collection of asymmetric and symmetric parts that perform a combining function that is defined in a schema. The schema may be tailored to an application such as a secure channel or a CKM digital signature.

The Policy manager may rename an algorithm and operating mode. Different algorithms may be put to use for different purposes and an algorithm's name may reflect its use. The names of the algorithms that a user has permission to use are contained in the user's credentials. Since the Policy and Credential Managers control access to algorithms, applying different algorithms has the effect of further compartmenting access to encrypted data.

Symmetric key algorithms are used in CKM for encrypting objects. They are also used internally in CKM processes, such as in the combiner. Asymmetric key cryptographic systems may also be used in CKM for message authentication, credential distribution and the key exchange protocol between smart card and workstation.

A biometric reading may provide the basis for a user's private key used for message authentication. In this case the private key need not be stored since the user can recover it by taking the biometric reading. The public key used for authentication is usually derived from this private key and is stored in the user's Credential Manager's database. To base the private key on a biometric reading requires special properties regarding the biometric. Normally, these special properties do not apply, in which case the private key will need to be generated by the user and stored, usually on a user's host platform or smartcard. A secure backup is needed for this private key in case of loss. Note that the Credential manager will not have access to a user's private key used for authentication.

The public-key pair for each user that is used for credential distribution is generated and stored by the Credential Manager. Since these key pairs are used only to encrypt information from the Credential manager to the user, the private key does not have to remain unknown to the Credential Manager. Thus, the Credential manager stores both the public and the private keys for its users in its database. User's public keys are used to encrypt the key used to encrypt user credentials for distribution. The Credentials Manager stores user's private keys only for backup purposes. Users must have their own copy of their private key so they can decrypt their credentials when received.

### User Credentials

User credentials (or labels), contained in computer files, include a user's permission set, i.e. the label splits, their associated label names and indices that can be used for encryption (write permission) and decryption (read permission), and the permissions to algorithms that may be used. In addition, the organization name and associated split, maintenance level and associated split, header encryption split and certain parameters to be used by the organization are contained in a user's credentials. Policies, such as minimum password length, are also included in the user's credentials. When digital signatures are used, a copy of all the organization's Credential manager's public keys is included as part of the Framework, as well as the user's signed certificate.

In assigning a permission set to a user, the Credential manager looks to that user's role and its related responsibilities and privileges within the organization. Role templates and role hierarchies in the Credential manager software aid the Credential manager in this job. An individual's role may change; hence, credentials may be reissued with different labels, or may even be revoked altogether for an individual who has left the organization.

User credentials are encrypted and must be decrypted by each user before use. Decrypting the credential file is the basis for cryptographically identifying the user. The key used for encryption and decryption is derived from the user's id, as well as a password that only the user knows. Some unique data, such as a date/time stamp associated with the file, or a random number residing in a place different from that of the credentials file is also used. Every time the credentials file is decrypted for use, it is re-encrypted using different data. Since this data is always changing, the credentials file is encrypted with a different key after every use. This increases the work that an adversary must do to break a user's credentials. Since a piece of information other than a password is used, an adversary must determine this unique data before a password guessing attack can take place.

When a smart card is used, a random number can be stored on the smart card. This has the effect of tying the user and the smart card to the credentials file. In this case the credentials file cannot be decrypted without the smart card.

When biometrics are used, the biometric reading offers another piece of information from which to derive the credentials file encryption key if the reading can be reproduced exactly each time. This further ties the user to the credentials file. However, if the biometric reading cannot be reproduced exactly each time it must be compared to a stored baseline template for variance calculation purposes. In this case the template is not used in the encryption of the credentials. Instead, it is used for authentication and is carried in the credentials where it is used to compare to each biometric reading.

The credentials file carries an expiration date. Beyond this date the credentials file is useless. Each CKM encrypted object can contain a time stamp in its header. Objects encrypted by others beyond the expiration date of the credentials cannot be decrypted. The maximum time-out value—the time from credentials issuance to credential expiration—is set by the Policy Manager. A Credential manager may further restrict the time-out but cannot extend the time-out value when issuing credentials to a user. To use CKM after credentials have expired, a user must have credentials reissued by that user's Credential manager.

Upon issuance, or re-issuance of a credentials file, the Credential Manager software generates a new “first-use” password. Before the new credentials can be used for the first time the “first-use” password must be used to decrypt the credentials. The password may be changed for subsequent encryption and decryption of credentials.

The “first-use” password is forwarded to a user using a different communication channel than that used to transmit the credentials file. An asymmetric key cryptographic schema may be used to encrypt a “first-use” password. A private key provided by the Credential Manager is used to recover this “first-use” key and decrypt the credentials.

When biometrics is used in the encryption of the credentials file, the user's public key is contained in the credentials and will be used as a check. Only the correct biometric reading will produce a private key that generates a public key that matches the one in the credentials.

To be able to encrypt, decrypt, sign, and verify objects, a user must have credentials. They provide most of the “secret” information needed for these actions and are tied to a user with strong authentication techniques when the full CKM system is used. A user's access permissions may be revoked by taking away that user's credentials or by allowing them to expire without renewal. There are other revocation actions that can be taken. If credentials are required to be stored on a server then a user's credentials may be removed immediately. Once the Policy Manager issues a new maintenance split, user credentials that have not been updated are useless for any data encrypted after this update—a further means to force a user off the system.

### The Header

Every encrypted object contains added information that is referred to as the CKM header as an essential part of the CKM schema. This information is needed to decrypt the object. It contains, as a minimum, an index to the label splits and the algorithm used in the encryption process, the organization name, the maintenance level pointing to the maintenance split to be used, and the random split. The random split is encrypted by using an encryption key based upon the same label splits used to encrypt the object. To be able to recover the random split, a user must have read access to the label splits that were used in encrypting the object. The organization split, maintenance split, and label splits that are contained in a user's credentials, along with the random split recovered from the CKM header, allow the encryption key to be recovered. The object may then be decrypted.

Also contained in the CKM header is a time stamp indicating the date and time the object was encrypted. CKM will not allow a user with credentials that have expired before this date to decrypt the object.

The ID of the user who encrypted the object, as well as the identity of that user's Credential manager is contained in the header. If a digital signature is used, it is contained in the header along with the user's certificate. With the appropriate Credential manager's public key, all of which are contained in each user's credentials, the certificate may be decrypted to recover the signing individual's public key. This public key is used to verify the digital signature once the message is decrypted.

Most of the header itself is encrypted. The choice of the encryption schema can depend on usage. Data contained in the header can offer a basis for certain types of information searches and database queries. Search engines could contain logic to look at the CKM header to provide data separation. Since decryption the header does not reveal message contents, a process may be placed on network monitoring and control devices to check traffic for verification, integrity, routing, etc. without revealing the encrypted data. For example, label information contained in the header can be the basis for keeping encrypted data confined to a network by having routers prevent data with particular labels from crossing certain network boundaries. Thus, by using the header, CKM lends itself to managing and encrypting data-in-transit over a network, as well as static data-at-rest.

### Data Separation

Data separation is the process of assigning data to and restricting access to each category based on need-to-know. One way of accomplishing this is by physically placing data where unauthorized people can not access it. However, providing physically separate networks or machines to host different sets of data is costly. CKM provides a way of separating data so those with authority will have access to it without having to physically keep the data confined to different networks, hard disk drives, servers, etc.

### Key Recovery

Key recovery in CKM is an organized process to regenerate the encryption key requiring several deliberate events, plus access to the encrypted object. The Policy Manager may initiate this process and provide any Credential Manager with all label splits required. The Credential Manager is able to provide credentials with read capability for label splits that were used to encrypt the object.

Note that an expiration date is set for credentials files. It is possible for the Credential manager to create a credentials file that is valid for only one day. For example, pursuant to a judicial order, law enforcement may be issued read-only splits to recover information they need. They would not be able to recover information encrypted subsequently.

Another reason to use key recovery would be for recovering data encrypted by an employee that has left the organization, died, or who has become incapacitated. The loss of an individual does not mean that data encrypted by that individual cannot be recovered.

If a user's original credentials are lost or the password is forgotten, CKM can recreate a user's credentials.

### User Authentication Enhancements

Strong user authentication requires something that an individual knows, something possessed by the individual, and something that individual is. Passwords, something known, are used for rudimentary user authentication. Smart cards (or other tokens) are something possessed. Biometric data is something an individual is. All three may be used in a CKM schema.

### Smart Cards

Smart cards may be used to hold sensitive pieces of information in the CKM process. A random number stored on the card may be used as a piece of information in building the key to encrypt each user's credentials. This ties the smart card to the credentials. Without the number stored on the card, decryption of a user's credentials is not possible. The user needs the card to complete session establishment before the CKM system can be used. Other pieces, such as a password, are still needed to log on to CKM. The smart card alone is not sufficient to start a session, thus defeating an adversary who has stolen or otherwise acquired a user's smart card.

User credentials may be stored on the smart card. This would let the user travel to other machines that are not part of the organization's main network and still be able to use the CKM system.

Security is enhanced by keeping decrypted user credentials in the smart card's memory only for the duration of a session, as well as by running the CKM combiner process on the smart card's processor. Local processing within the card increases the workload of an adversary who is attempting to view the internal workings of CKM processes in order to gain useful information about secret keys.

### The EagleCard™

The EagleCard™ is an ISO compliant smart card that has enhanced processing ability and greater memory than current smart cards. It includes tamper resistance and hardware random number generation. The processing capability internal to the card may be used to reduce CKM task processing on the host platform. Even though the bandwidth between the card and the host platform is limited, with CKM only small amounts of data are transferred between the two. Larger memory within the card also makes it possible to store user credential files, as well as “private” data associated with CKM applications that are maintained in SILOS (Secure Independently Licensed Object System).

To keep “secret” information, such as splits, from being revealed to someone monitoring communications between the card and the workstation, the communications between the EagleCard™ and the host platform are encrypted. The key agreement protocol used to exchange the encryption key is between the card and the host platform that would result in a secure channel between the card and the host platform. No additional intelligence is required in the card reader.

Random numbers are needed to establish a secure channel and for object encryption. In the absence of a hardware random number generation, CKM resorts to a software pseudo-random number generator. A feature provided with the EagleCard™ is hardware random number generation capability. Using the hardware source provides much better random number generation and contributes to the strength of the overall security of the CKM system.

With a secure channel between the card and a host platform, data may be securing transferred from the card to the host platform. A large capacity card offers multiple applications to concurrently exist on the card. A SILOS process will assure the secure co-existence of multiple application-specific data while stored and transferred from a card. The card becomes an extension of the CKM process while the mechanics of CKM ensure the enforcement to the access of the information while protecting the information through encryption.

In the case of a smart card, the Issuer of the card can enforce through encryption a secure delegation of authorization to partners that would enable the partners to create a specific data silo on a card for partner related applications. To affect the system's process, memory allocation on the smart card is first established; encryption is needed to enforce the allocation of the memory by Partner-specific keys (as credentials associated with CKM). The memory enforcement becomes an extension to a secure channel capability. Encryption through CKM applies role based access control to enforce data separation for which the data is associated with differing applications. This part of the Constructive Channel Key focuses on the enforcement of SILO functionality associated with memory allocation and a secure channel. An additional functionality exists with the SILO that the Constructive Channel Key is applied to multi factor authorization. The binding of multi-factor functions that can include biometrics, passwords, and card id to the front end of a SILO process through a Constructive Channel Key results in a common encryption key management architecture to extend the security paradigms associated with Identity Management, with card memory enforcement, and finally a secure channel between the card and a host platform.

The Silos process is another methodology to provide a multiple level access. The goal is to provide access control to objects with SILOs.

A system process flow for Silos can leverage the objectives and the exemplary aspects of U.S. Pat. No. 7,016,495—Multiple Level Access System. A user can encrypt (or write) an object for a SILO with one or more particular credential keys included in a user's profile, such that subsequent decryption of the encrypted object by another user (or the original user) requires corresponding or otherwise authorized credentials. A user can select one or more credentials with which to interact with a particular object or objects in general, or selection of credentials can be automated. A credential and an object can correspond to a multiple-level access level to effectuate a partitioned-access scheme for a card's memory. The SILOS process can be further extended into a user identification and authentication by the addition of a biometric event such as a fingerprint Match-on-card for encrypting the overall memory as defined in U.S. Pat. No. 6,845,453 (Multiple Factor Based User Identification and Authentication).

### Biometric Data

The process of using a biometric device can generally be described as follows: Initially, a biometric reading taken from the device is digitized; the digital representation is mathematically transformed, and then is stored somewhere as a template. Subsequent biometric readings are compared to this template for verification. Biometric readings may also be used for identification by comparing a biometric reading to templates stored in a database (for example: One to n where n is many biometric reading references). A match from this database establishes identification. CKM uses biometrics only for verification where the biometric reading is compared against a stored biometric template (for example: One-to-one where there is only one biometric reading reference) during session establishment.

In general, biometric readings will vary by a small amount. A variance from the template value is allowed and is set according to the application and security requirements. This variance is an adjustable factor chosen from the false-acceptance and the false-rejection rates.

Most biometrics can only give a hard decision (that is, a “yes or no” answer) to the template comparison. If higher false-acceptance rates can be tolerated, mathematical techniques applied to some types of biometric readings can be used to transform the reading into a repeatable number that can be matched exactly to a stored template. With a repeatable number, biometric data can be provide CKM with information used to derive keys used in symmetric and asymmetric key cryptosystems.

It is desirable not to store a biometric reading, including the biometric template, even if it is encrypted. If a repeatable number can result from biometric readings, these biometric values may be used as a piece of data to build the key to unlock user credentials. They may also be used as the basis for the private key in asymmetric key systems used for message authentication.

During user verification, upon decryption of the credentials file using a biometric value, the user ID field in the decrypted credentials file is compared to the ID typed by the user. If the comparison is favorable, the user has been authenticated and the data in the credentials file has been decrypted correctly. Biometric data as part of the key used in encrypting a user's credentials file ties that user to the credentials.

Since other pieces of information, such as a password, user ID, and other data, such as a random number, are used to create credentials encryption key, higher false-success rates from the biometric can be tolerated. Even if two people generate the same biometric value, the credentials encryption key would not be the same for the two since their user ID's and passwords, as well as ephemeral data are not the same.

A user's private key for digital signatures may be based on the user's repeatable biometric template. A user's public key is generated from the private key. The public key is recorded in the user's Credential Manager's user database as part of the enrollment process. Requiring the user to be present for enrollment establishes identity but other acceptable methods establishing identity can be used.

When repeatable biometrics readings are used, a user's private key, although not stored, is recoverable if lost. In this case a biometric reading would establish the private key and generation of the corresponding public key may be checked against that stored in the Credential Manager's database.

If a repeatable number cannot always be guaranteed from a biometric reading, then a biometric template must be stored for comparison with subsequent biometric readings. In this case the biometric template would be encrypted within a user's credentials file. During user authentication, the credentials file would be decrypted, recovering the biometric template, and then the biometric reading taken for authentication would be compared to the template and a “yes or no” answer would result.

### Message Authentication

Asymmetric key cryptographic systems are used in CKM for the three message authentication related objectives stated above. If only data integrity is desired, message authentication codes may be used. If data integrity coupled with secrecy is required, message manipulation codes with asymmetric key encryption can be used. To meet all three message authentication objectives, while providing secrecy, digital signatures are used.

### Manipulation Detection Codes (MDCs)

If privacy and data integrity without regard to data origin authentication and non-repudiation are desired, an MDC combined with CKM encryption may be used. An MDC is basically an “unkeyed” hash function that is computed from the message. This hash is then appended to the message, and the new message is encrypted.

From verification of data integrity, a recipient decrypts the message, separates the hash from the message, computes the MDC of the recovered message, and compares this to the decrypted hash. The message is accepted as authentic if the values match.

### Message Authentication Codes (MACs)

If only data integrity without regard to privacy is needed, a MAC can be used with a CKM schema. The working key for the MAC is constructed in the same way as that for the key used for encrypting a message for privacy, i.e. by using the CKM combiner process with label splits, organization split, maintenance split and a random split.

To verify data integrity the recipient of the MACed message uses the splits associated with the message to rebuild the key for the MAC. A new MAC is then calculated by the recipient and compared to the MAC sent with the message. If the two MACs match, the message is accepted as not having been altered.

It is not expected that MDCs and MACs will be used as often as digital signatures. Therefore, MDCs and MACs will not be mentioned in the process descriptions that follow.

### The CKM Applications

Security for an application begins at a log-on—a user must be authorized, access rights established, and the on-going application process needs to contain sufficient depth to protect the data and to protect the security process, itself.

Use of a CKM schema is contingent upon successful logon and decryption of user credentials. Session establishment begins when a CKM enabled application is activated on a host platform. The host platform prompts the user to present the smart card, user biometrics, user ID and password (logon data). An encrypted channel is established between the host platform and smart card and the logon data is transferred to the smart card where a key is generated to decrypt the user's credentials. The credentials may reside on the smart card or some other location, in which case the encrypted credentials file would be sent to the smart card for decryption and use. Upon successful logon, the credentials file is re-encrypted and stored and a decrypted copy is kept in the smart card's memory for use during the session.

Note that three factors may be needed to complete logon—a password, a smart card (or token) and biometric information. Without knowing the password, an adversary needs to guess or search the whole password space. Random bits are used as a start for the credential decryption process so that if password guessing were used the output could not so easily be detected by the adversary as correct. Changing these random bits continually prevents an adversary from bypassing the process by “replaying” past results. Password policies, such as minimum characters required in a password, increase security when passwords alone are used for user authentication. Passwords alone are still considered weak authentication. Smart cards and biometrics are recommended for strong authentication.

The smart card must be present to complete logon. Putting random bits for the credentials file key generation on the smart card cryptographically ties that card to the user's credentials and hence to the user. The smart card alone will not complete the logon without a user's password. The password is not stored on the smart card, and so loss of the card to an adversary does not compromise a user's password or the user's credentials.

Using biometric data as a piece of information to build the key to decrypt the user's credentials cryptographically ties the biometric data, and hence the user, to the credentials file. Thus, knowledge of the user's password and possession of the user's smart card will not be enough information to decrypt the user's credentials. Compromise of the password and smart card does not disclose a user's biometric data, as it is not stored on the card, or anywhere for that matter, even in an encrypted form.

SILOS may be used to further protect access and protect application data. The transfer of secure data from the card or a token can be through a secure channel. The whole CKM cycle administered through a Framework and engaged through various CKM schema ties the security of the application to an encryption systems paradigm.

### Detection

The intent of detection is to notify certain individuals and to take certain actions whenever events indicative of intrusion, tampering or failure have taken place. At its simplest, detection is provided with audit of selected events. The minimum events to be audited are determined by the Policy Manager.

Detection can take other forms, such as statistical tests for randomness on generated random numbers. Weak cryptographic key detection may also be performed. These types of alarms would notify or stop a user from continuing with an action that might compromise the security of the system.

An example of another technique is monitors that can read CKM headers periodically, or at random, and verify the label sets contained therein against a user's issued labels per the Credential manager's database. This would aid a security administrator to detect when someone might be trying to gain unauthorized access.

There are many techniques, some of them hardware based, that can be used for event detection and alarm in CKM. Use of these will be under the control of the Policy manager and the Credential Managers.

### Supporting Application Usage

CKM technology can provide an effective system for encrypting data-at-rest. It can also provide a suitable system for encrypting data-in-transit. CKM can be extended beyond the application protocol level to lower layers, such as layer 2 in the OSI stack. The CKM encryption protocol to establish the session key for the channel can be adapted to the parameters of the communications environment.

An application programming interface implementing CKM may be used to develop secure applications at OSI layer 7. Software may be used to provide file and e-mail encryption, incorporating selected elements of the CKM technology described herein. CKM may also be used to add encryption to audio and graphics applications.

In support of CKM applications, digital signature and secure channels are essential elements of a security solution.

Encryption with Digital Signature

The Digital Signature may be incorporated into the CKM Framework from a separate PKI infrastructure. A PKI Certificate is included in a digital signature methodology. In this case, the Framework is a vehicle for the digital signature, but the verification and revocation are done outside of the Framework.

Digital signatures are used to provide data origin authentication, data integrity, and non-repudiation. The infrastructure provided by a CKM Framework supports a form of a Public-Key Infrastructure (PKI) that distributes signed certificates and public keys used in digital signature verification. In other proposed public-key systems the certificate authority takes the form of a database on a server that uses query via a network. In a CKM Framework, Credential Managers may be viewed as certificate authorities. All information for verifying digital signatures is provided in each user's credentials and in CKM encrypted objects. Additional bandwidth due to network and server processing is not required as it is in other public-key systems.

The certificate for a user is signed by that user's Credential Manager. Each Credential Manager has its own public and private key. The public keys of the organization's Credential Managers are provided in each user's credentials. The Credential manager encrypts, i.e. signs, a user's ID and public key combination with the Credential Manager's private key. This is a basic user certificate. It may be decrypted only by using the Credential Manager's public key.

A user's certificate is contained in that user's credentials so that it may be sent with CKM objects the user has signed. The recipient of a signed object uses the Credential Manager's public key to decrypt the sender's certificate and recover that user's public key. The recovered sender's public key is then used to verify the sender's digital signatures on the signed object.

A user's biometric template, when available, can form the basis of a user's private-key. For example, in the El Gamal Signature Scheme, a public key is the combination of a prime number, ρ, a primitive element, α, and a value, β, computed from a private number α. This private number is usually picked at random. However, in CKM the user's biometric template could become this private number, or part of this number. Because of this, private and public keys used for authentication are tied to an individual. The public/private keys may be recovered (negating the need for storage) if a repeatable biometric value can be obtained.

In a different view, a Digital Signature may be created through a mathematical relationship derived from a CKM schema. An example can be found in a Constructive Key with a DNS signature model.
Constructive Key for Identity Management with a DNS Signature Model

The Domain Name System (DNS) security model is based on a Public Key Infrastructure (PKI) with a root asymmetric private key that is mathematically morphed into its complementary public key for worldwide network distribution. The private key is kept secret while the public key of the pair is distributed to Internet Domain Name Resolvers everywhere. Rolling over or changing the private key must be smooth and cannot cause any interruption in providing the DNS service.

An introduction of a dynamic encryption component to the Private/Public key model would provide an efficient roll over and add another dimension of protecting the secret part of the keying material. The CKM Signing can be extended to all users of the Internet as the Domain Name System is expanded.

The split key framework identified in CKM can be viewed as a dynamic encryption component that can be modified for an encryption signing.

The CKM Signing framework consists of the following:
1. Start with a standard CKM framework that includes asymmetric and symmetric key splits.
2. The asymmetric key split may be a Diffie-Hellman with Ephemeral or an Elliptical Curve with Ephemeral representing a Credential. The choice of 512 bits or larger key space for the asymmetric key split is dependent on a risk and performance assessment.
3. Within the symmetric key splits, the Maintenance Key Split would be set for a predetermined time limitation. Or, the Maintenance Split Key could be updated according to a key maintenance schedule. A symmetric Random Split Key would be generated for each Resolver (in this case, the action with a Resolver would be the same as a new session under a CKM encryption). The overall CKM combiner that mathematically combines the asymmetric and symmetric key splits is a front end to the signing process.
4. The Working Key output from CKM is a bit string that can be further combined with a Signature nonce (or random number) to create a Private Diffie-Hellman asymmetric key. The resultant Private D-H asymmetric key is combined with the Ephemeral Private Key resulting from the initial credential asymmetric split key CKM process. (The NIST Digital Signature Algorithm (DSA) model based on FIPS 186 can be used for the mathematical combining.)
5. The DSS, based on the CKM Signing framework, can be used to sign the domain name.

The Public key and selected parameters of the DSS signing are distributed through the public network. A Resolver would verify the integrity of a DSS-signed domain name with the Public key. The Private key with the key splits that were associated with the CKM combiner would remain with the Root, and the DSS Private key needs to be protected as a secret.

To effectuate a key rollover, the Maintenance key split can be updated and a new DSS private/public key generated. The introduction of CKM key split adds additional integrity to the DSS framework. The new public DSS key would need to be distributed within the network to all Resolvers. The distribution and policy use would be in concert with DNS guidelines.

The Constructive Signature may also be applied to a digital enforcement for non repudiation associated with secure data found in SILOS.

### Constructive Channel Key Mechanics for a Secure Channel

This feature provides a linkage between a SILOs process to protect data from a smart card (or a token) to a host platform.

The context is to extend a secure channel from the token (for example, a smart card) and a reader or client.

The feature includes a key agreement protocol that contains the rudiments of a CKM process. The purpose of this model is to establish a secure channel between a smart card with silos and a client or some other end point that the card would communicate with. Preferably, the encryption protocol takes advantage of CKM features as described above.

The operating environment used in this context can be any known environment, such as that provided by Global Platform (http://www.globalplatform.org/). In that platform is identified a methodology to establish a secure channel to and from a card. Global Platform is a card industry acceptable environment.

For example, according to the invention, the environment identified by Global Platform as SCP01 (in the specifications) can be modified as follows.

1) The session key agreement will use a 1024-Diffie-Hellman key agreement based combiner to create the encryption, MAC and Key Encryption Keys (KEKs).

2) The secure channel will use AES 128 instead of 3DEA 2 key as specified in Global Platform

3) The MAC will be 16 bytes instead of the 8 bytes as described in Global Platform.

All other aspects of the secure channel can conform to SCP 01 after taking into account the block size difference between DES and AES.

The actual computation of the session keys and initial IVEC will be as follows.

1) Issuer has the card public key which could be considered the keying part of a CKM credential.
a. Issuer computes an ephemeral key pair using the pre-established enterprise domain parameters (p, g and q)

2) The shared value for the ephemeral private and the card public key are computed using DH Key Agreement.

3) The ephemeral private key is destroyed.

4) This shared value is combined with a static key value (could be a pre-placed random value (symmetric value) or a symmetric value derived from two asymmetric values of the member private card key and the enterprise public key that are exclusive ORed and linked to a card identifier such as a serial number) to create 128 bytes of key material.

5) This key material is split into 4 parts of 32 bytes each.

6) The first block is truncated and used for the session encryption key

7) The second block is truncated and used for the session MAC key

8) The third block is truncated and used for the session KEK

9) The last block is truncated and used for the initial IVEC

The card will receive the ephemeral public key, and performs the DH key agreement using the card private key which could be considered the keying part of a CKM credential to recreate the shared value. Then steps 4 through 9 are repeated on the card.

This secure channel allows for the creation of protected communications by the issuer/authorized party that can be sent to the card through any means. The card does not have to be present to initiate the channel. This allows for a push model where updates can be pushed to the client through any communications media, including Web or e-mail. The card is the only one able to decrypt the information once the packet of information has been created. All data/command payloads are encrypted in transit and are only decrypted by the card for which they were created.

Thus, this feature applies a CKM model through a key exchange with Diffie-Hellman for a credential and a random number as the symmetric key split value.

We claim:

1. A method of generating a constructive channel key, comprising:
providing an issuer with a card public key as the keying part of a CKM credential;
computing an ephemeral key pair by the issuer using pre-established enterprise domain parameters;
computing a shared value for the ephemeral private key and the card public key using D-H key agreement;
destroying the ephemeral private key;
combining the shared value with a static key value;
splitting the static key value into four blocks;
truncating the first block to be used for a session encryption key;
truncating the second block to be used for a session MAC key;
truncating the third block to be used for a session key encryption key; and
truncating the fourth block to be used for an initial IVEC.
